(19) United States
(12) Patent Application Publication
(10) Pub. No.: US 2023/0226894 A1
(43) Pub. Date: Jul. 20, 2023

(54) FOLDING CAP FOR PICKUP TRUCKS

(71) Applicant: Ossie Rankin, Hinesville, GA (US)

(72) Inventor: Ossie Rankin, Hinesville, GA (US)

(21) Appl. No.: 18/151,661

(22) Filed: Jan. 9, 2023

Related U.S. Application Data
(60) Provisional application No. 63/299,454, filed on Jan. 14, 2022.

(51) Int. Cl. B60J 7/14

(52) U.S. Cl. CPC B60J 7/141; B62D 33/02

(57) ABSTRACT

An integral compact collapsible cap for a pickup truck having multiple interconnected folding panel members hinged together forming a cap on the truck bed. Side and end panels are hinged to and from a top member deployable from a flat storage position in the truck bed to a co-planar vertically spaced position over the truck bed. Manually operated secure and release latch arms on the deployed side panel ends registerably engage end pins on a cap mounting frame secured to the truck bed rails of the truck with a deployable rear and access panel having doors there within.

This application claims the benefit of U.S. Provisional Application No. 63/299,454, filed on Jan. 14, 2022

### BACKGROUND OF THE INVENTION

### 1. Technical Field

This device relates to camper body attachments for vehicles, specifically pickup trucks and the like.

### 2. Description of Prior Art

Prior art devices of this type have been developed to provide a variety of fixed removable and deployable bed cap configurations, see for example U.S. Pat. Nos. 4,277,098, 4,542,911, 5,016,935 and 6,749,252.

U.S. Pat. No. 4,277,098 is directed to a foldable truck cap assembly having a plurality of separate cap sections pivotally attached together for storage on top of the vehicle's cab in an accordion fashion.

U.S. Pat. No. 4,542,911 claims a folding cap for pickup trucks equipped with a fifth wheel hitch to convert the truck bed into a camper body.

U.S. Pat. No. 5,016,935 illustrates a collapsible cap for a pickup truck having hinged intermediate panel members to form a cap over the truck bed.

U.S. Pat. No. 6,749,252 discloses a fold out camper for a pickup truck having a frame with extending oppositely disposed camper bed and rear access panel.

### SUMMARY OF THE INVENTION

A self-contained compact collapsible cap for a pickup truck having a bed engagement frame with a top cap panel from which foldably extends side panels and a cap access rear door panel assembly. Integrated fasteners secure the deployed panels to the bed engagement frame and to one another when in a foldable collapsed transport position in the bed of the truck and to the truck bed in an open position thereon.

### DESCRIPTION OF THE DRAWINGS

FIG. 1 is a perspective view of the utility cap of the invention deployed on a pickup truck.

FIG. 2 is a perspective view of the utility cap in closed collapsed position within the truck bed.

FIG. 3 is an end elevational view thereof.

FIG. 4 is a perspective view of the utility cap within the truck bed before deployment.

FIG. 5 is a perspective view thereof with the utility cap in partial deployed position.

FIG. 6 is a perspective view thereof with side panels being deployed.

FIG. 7 is a perspective view thereof with the access end panel being deployed.

FIG. 8 is a perspective view of the utility cap mounting frame.

FIG. 9 is an end elevational view of the utility cap open and secured within the truck bed.

FIG. 10 is a partial side elevational view thereof.

FIG. 11 is an enlarged end elevational view of the utility cap in folded elevated position with depending sidewalls and end access panel assembly shown in broken lines on a truck bed.

FIG. 12 is an enlarged bottom plan view of the side panel interior.

FIG. 13 is an enlarged bottom plan view of the top panel interior with folded rear access panel and side panels broken away.

FIG. 14 is an enlarged graphic side elevational view illustrating utility cap top panel and rear end access panel assembly in deployed in solid lines and folded position in broken lines.

FIG. 15 is an enlarged end elevational view of the rear access panel in open deployed position with side extension wings extending and side cap panels and bed rails in broken lines.

FIG. 16 is an exploded view of the utility cap and truck bed illustrating multiple panels and mounting frame independently.

### DETAILED DESCRIPTION OF THE INVENTION

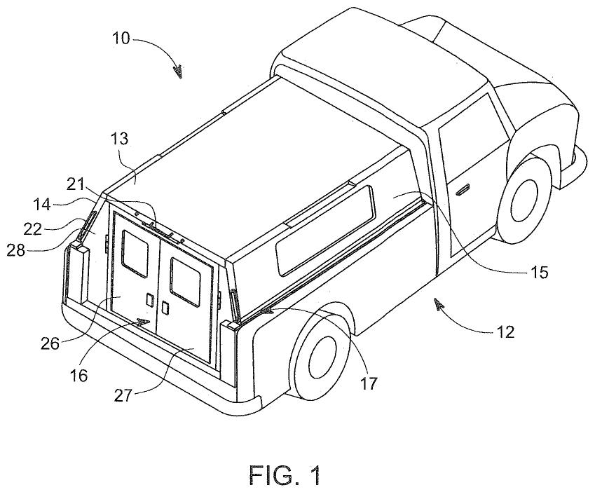

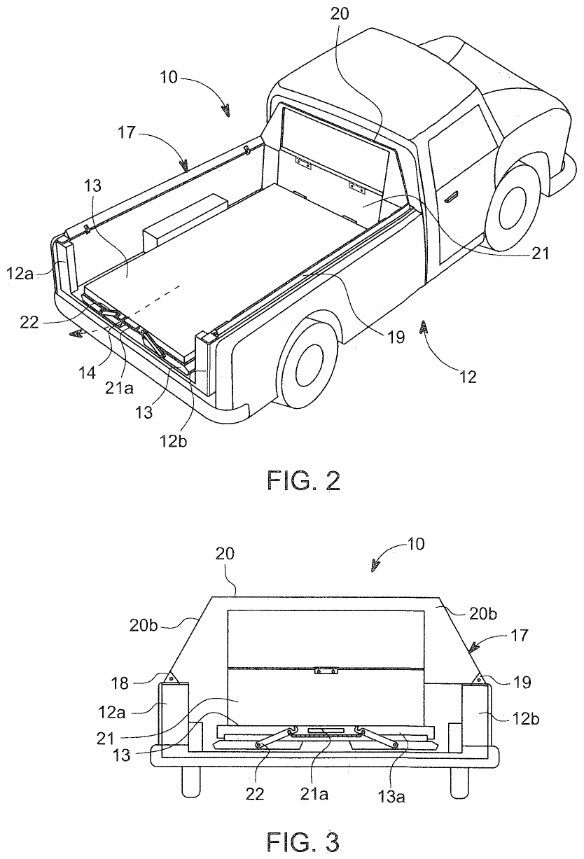

Referring to FIGS. 1, 2 and 3 of the drawings, a utility cap attachment 10 of the invention can be seen for a pickup truck and bed 12 having a top storage panel 13 with oppositely disposed spaced parallel side panels 14 and 15 and end access panel assemblies 16 hinged H thereto. The side panels 14 and 15 and end access panel assemblies 16 are foldably secured to the top storage panel 13 as seen in FIGS. 2 and 3 of the drawings for storage prior to deployment.

A cap attachment frame 17 is selectively secured to the truck bed rails 12A and 12B by a plurality of C clamps illustrated graphically and well known within the art.

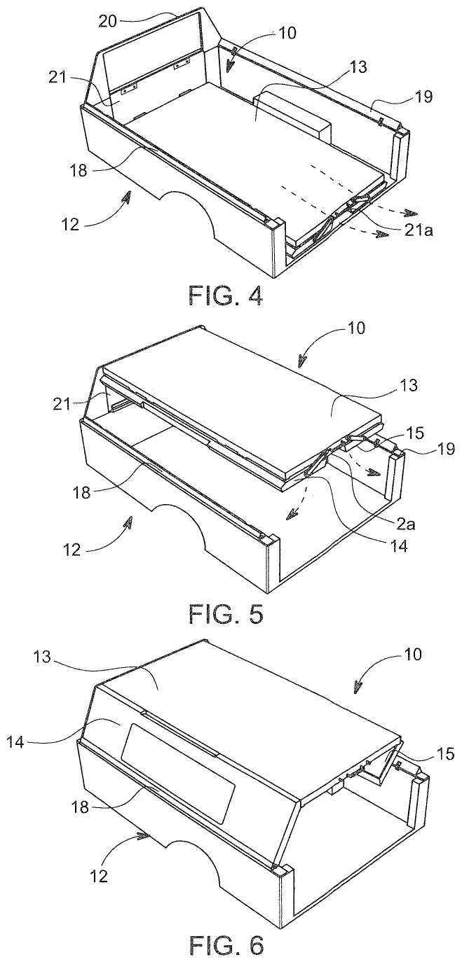

The attachment frame 17 has a pair of spaced parallel elongated members 18 and 19 positioned on and secured to respective bed rails 12A and 12B as noted. Each of the frame members 18 and 19 are cross sectionally triangular defining angular side panel engagement surfaces 18A and 19A as will be described in detail hereinafter. The attachment frame 17 has an interconnecting upstanding end member 20 as best seen in FIG. 8 of the drawings with a rectangular opening therein at 20A and oppositely disposed tapered opposing frame elements 20B. A frame support member 21 is hinged to and extends between the end frame member 20 and the top panel 13 on its depending end flange 13A. It will be evident that this orientation allows the top storage panel 13 with its respective hinge H side and end access assembly panel to be pulled forward as indicated by broken arrows by a handle 21A on its oppositely disposed free end 13B to a spaced parallel deployment position within the truck bed 12 as seen sequentially in FIGS. 4-7 of the drawings.

The side panels 14 and 15 each have a pivot retainment latch arm 22 on their ends 14A and 15A as best seen in FIG. 11 of the drawings that initially holds the respective panels 13 and 14 in storage position up against the top panel 13. The latch arms 22 have a pin engagement notch PN therein for aligned engagement with respective latch fitting pins 23 on the depending free end flange 13B of the top panel 13. Upon latch arms 22 release the respective side panels 13 and 14 pivot down for registration engagement with corresponding elongated triangular member surfaces 18A and 19A as hereinafter described and illustrated in broken lines.

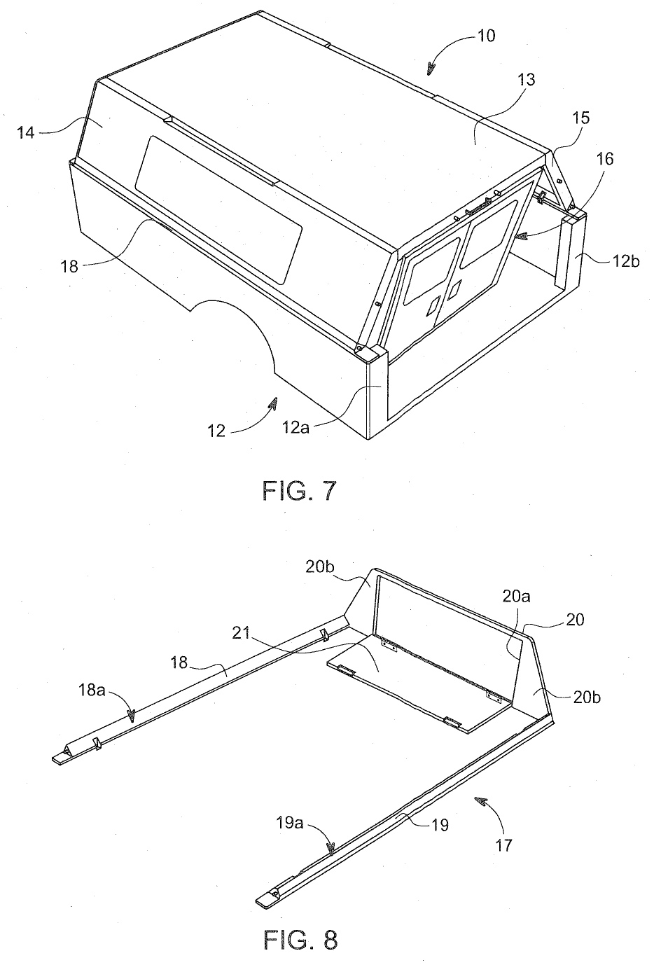

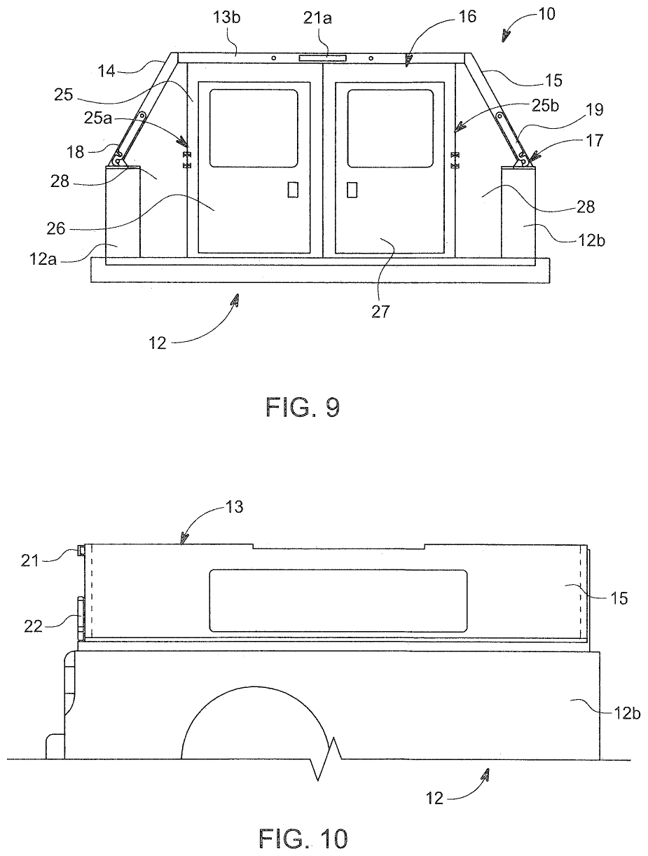

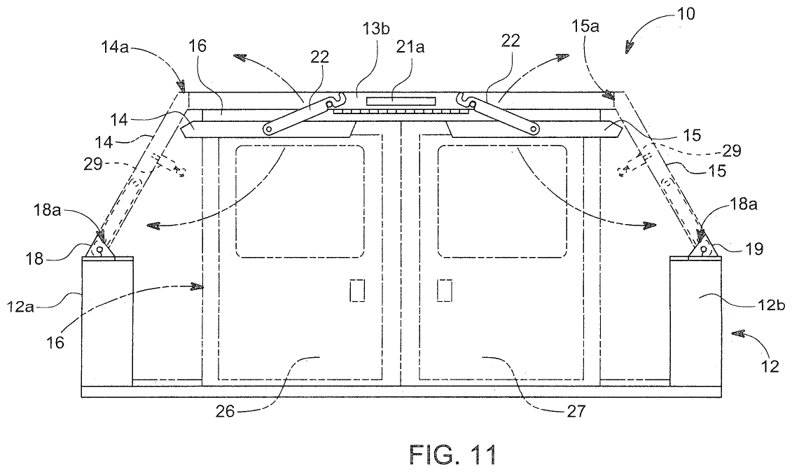

Each of the side panels 14 and 15 have elongated oppositely disposed parallel contoured upper and lower edges 14A and 14B and 15A and 15B with dual angular offset surfaces so as to define abutting upper surface with the corresponding respective right angles depending top panel side flange 13C and 13D. Correspondingly, the lower panel edges 15A and 15B for registration with abutting surfaces 18A and 19A of the triangular support frame members as seen in FIGS. 6, 9 and 11 of the drawings.

The respective latch arms 22 each have an end hook portion 22A and when rotated so as to engage registerably extending retainment pin fittings 23 on the corresponding respective free ends 24 of the triangular frame members 18 and 19 thereby retaining the deployed side panels 14 and 15 in place.

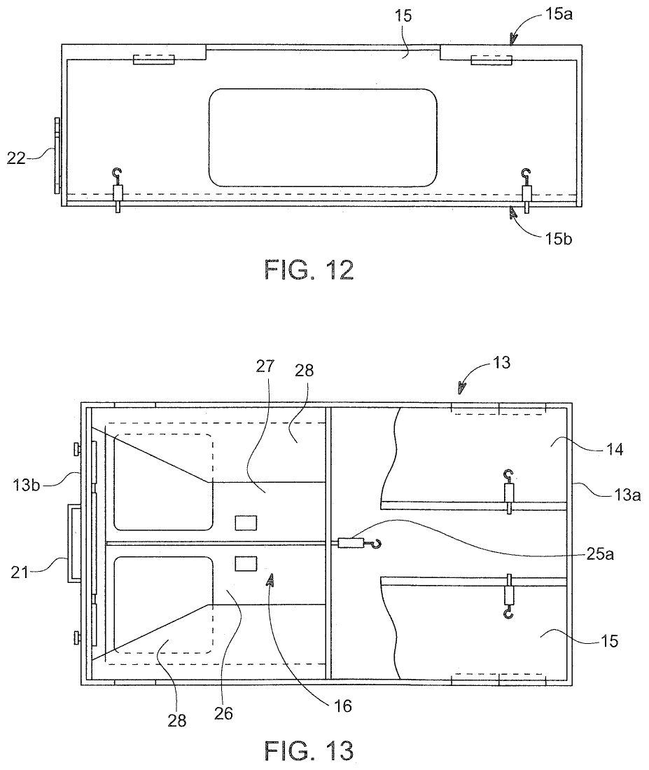

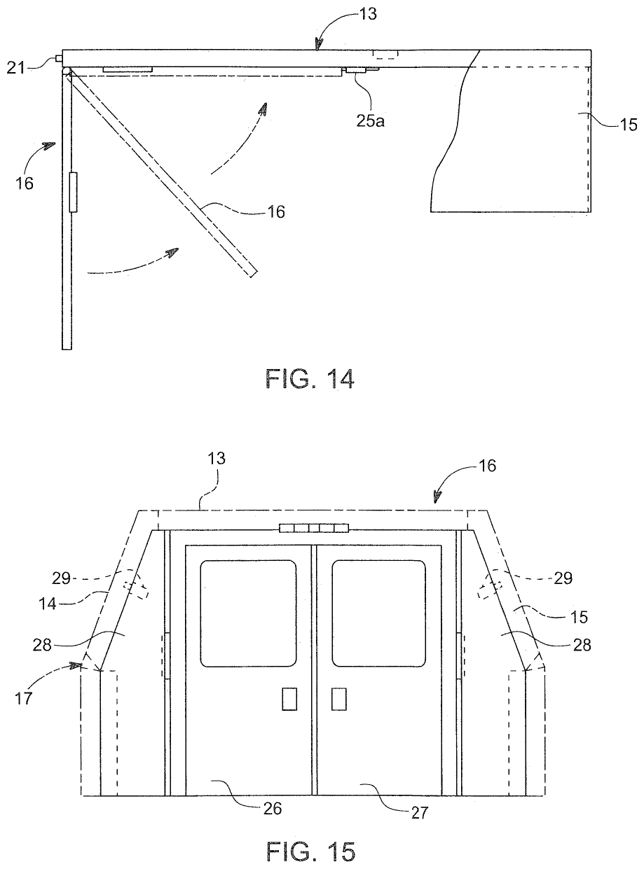

Additionally, each side panel 14 and 15 has spring pin latches L positionally spaced along its lower inner angle flange as seen in FIG. 12 of the drawings for selective registration and retainment with aligned retainment notches N in the corresponding frame members 18 and 19 as seen in FIGS. 4, and 8 of the drawings.

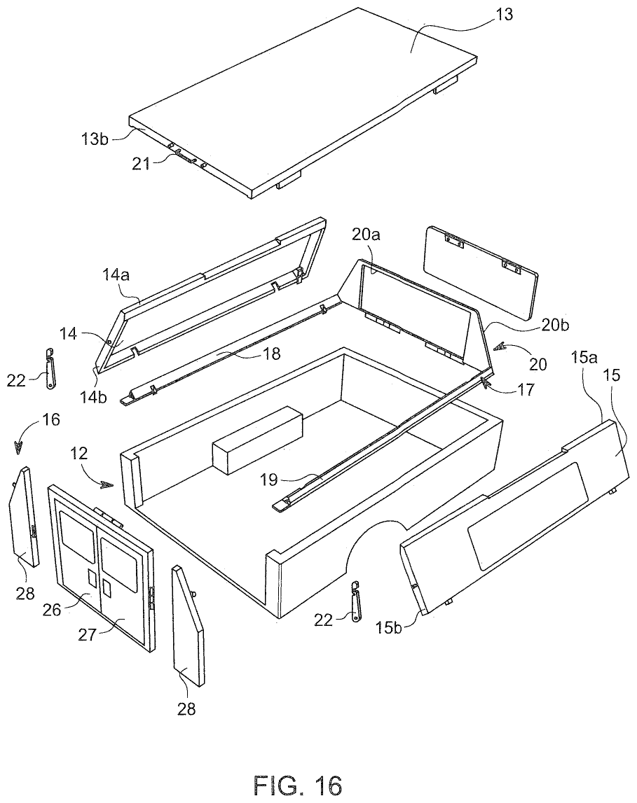

It will be evident from the foregoing description that the top storage panel 13 and the deployed side panels 14 and 15 are now self-supporting on the rails of the truck bed 12. Referring now to FIGS. 7, 11, 13 and 15 of the drawings, the end access panel assembly 16 can be seen having a door support frame 25 with of pair of hinged H access doors 26 and 27 positioned within. A pair of tapered infill panels 28 are hinged respectively to the door support frame 25 on oppositely disposed frame edges 25A and 25B each with a spring latch pin 29 positioned on the respective inner surfaces. The access panel assembly 16, as noted, is initially positioned against the inner surface of the top storage panel 13 and held by a spring pin latch 25A as best seen in FIG. 13 of the drawings. It will be evident from the operational orientation that the access panel assembly 16 is therefore positioned first against the top panel 13's interior with the respective side panels 14 and 15 folded up there against thereafter and secured prior to deployment.

Once the respective side panels 14 and 15 have been released by disengagement of their respective latch arms 22, they are secured to the mounting frame 17 as hereinbefore described. The access panel assembly 16 is then released via its spring pin latch 25A and hinged downwardly to a vertically deployed position as seen in FIGS. 1, 9 and 15 of the drawings within the truck bed 12.

As noted, the respective oppositely disposed hinge infill panels 28 are thereby opened and secured by the spring latch pins 29 to respective deployment side panels 14 and 15. The utility cap 10 now forms a weather tight enclosure on the truck bed 12 as seen in FIG. 1 of the drawings.

It will be evident that to release and fold up the utility cap 10 of the invention, a reverse panel orientation manipulation is required so that the now collapsed utility cap 10 so folded is laying flat within the truck bed 12 as seen in FIGS. 2, 3 and 4 of the drawings.

It will thus be seen that a new and useful compact collapsible utility cap for a truck bed has been illustrated and described and it will be apparent to those skilled in the art that various changes and modification may be made therein without departing from the spirit of the invention. Therefore I claim:

1. An integral compact foldable utility cap for a truck bed comprises,
a top support and storage panel, a pair of elongated side panels and an end access panel hinged to said top panel,
a cap attachment frame removably secured to rails of said truck bed, said top support panel in hinged communication with said cap attachment frame movable from a first truck bed engaged position to a second vertically spaced deployment position thereto.

2. The integral compact foldable utility cap for a truck bed set forth in claim 1 wherein said cap attachment frame comprises,
a pair of elongated triangular members secured to rails of said truck bed and upstanding interconnecting frame member there between.

3. The integral compact foldable utility cap for a truck bed set forth in claim 1 wherein said side panels have angled upper and lower elongated edge engagement surfaces registerable with said top panel and said cap attached frame respectively.

4. The integral compact foldable utility cap for a truck bed set forth in claim 1 wherein said end access panel has hinged access doors with hinged deployable infill side panels extending respectively therefrom.

5. The integral compact foldable utility cap for a truck bed set forth in claim 1 wherein said side panels have spring pin latches for registration retainment with said attached frame.

6. The integral compact foldable utility cap for a truck bed set forth in claim 1 wherein said support panel in hinged communication with said cap attachment frame comprises,
a frame support member hinged to said cap attachment frame and a depending end flange of said top support and storage panel.

7. An integral compact foldable utility cap for a truck bed set forth in claim 2 wherein said hinged side panel further comprises,
latch arms pivotally secured to the respective ends for selective registration with said top support and storage panel ends and alternately to said elongated triangular frame member ends on respective latch engagement retainment pins.

8. The integral compact foldable utility cap for a truck bed set forth in claim 4 wherein said deployable infill side panels have spring pin latches for retainment registration with said respective deployed side panels.
